(19) United States
(12) Patent Application Publication
(10) Pub. No.: US 2008/0087793 A1
(43) Pub. Date: Apr. 17, 2008

(54) MOLD FOR PRODUCING AN ARTICLE

(75) Inventor: Paul Shepheard, March (GB)

Correspondence Address: HENRY M FEIEREISEN, LLC, 350 FIFTH AVENUE, SUITE 4714, NEW YORK, NY, 10118, US

(73) Assignee: ELECTROVAC AG, Klosterneuburg (AT)

(21) Appl. No.: 11/686,026

(22) Filed: Mar. 14, 2007

(30) Foreign Application Priority Data
Mar. 14, 2006 (EP) EP06450036.6
Oct. 24, 2006 (EP) EP06450152.1

(51) Int. Cl. B29C 33/40; B29C 33/04

(52) U.S. Cl. 249/80; 249/205; 264/225

(57) ABSTRACT

A mold for producing an article to be formed therein is provided wherein the mold matrix material contains at least one type of carbon fibers. The mold matrix material comprises a phenolic resin. Thereby, a high operating temperature of the mold matrix material and a wear resistant mold can be achieved. Hence, use of the mold in a series production becomes possible. Preferably, the mold matrix material comprises carbon nano fibers.

### CROSS-REFERENCES TO RELATED APPLICATIONS

This application claims the priority of European Patent Applications, Serial No. 06450036.6, filed Mar. 14, 2006, and 06450152.1, filed Oct. 24, 2006, pursuant to 35 U.S.C. 119(a)-(d), the contents of which are incorporated herein by reference in its entirety as if fully set forth herein.

### BACKGROUND OF THE INVENTION

The present invention relates to a mold for producing an article to be formed therein, the mold matrix material containing at least one type of carbon fibers.

Nothing in the following discussion of the state of the art is to be construed as an admission of prior art.

Steel molds are typically used for the manufacture of products in a series production. Due to minimal wear steel molds allow a high number of products to be molded within the same mold. However, steel molds cannot easily be changed in their design which makes them unfavorable during prototyping or the pre-production phase. Therefore, until recently prototypes have been formed by casting in sand. These casts do, however, not allow high pressure molding. This results in prototypes that do not have the exact properties of the later product which will then be cast in a steel mold.

Therefore, molds made from epoxy resin were developed, that can be produced cheaply. While these molds make quick changes in the design of the prototype possible, they are subject to quite severe pressure limitations. If casting is performed at high pressure these molds tend to wear and break and are therefore not capable of being used several times.

In order to build prototypes having already the exact properties of the later product in a series production attempts have been made to find alternatives to the expensive steel molds but still allowing pressure casting. Amongst these British Patent Application No. GB 2 360 244 A describes a mold made from an elastomer such as polyurethane. While these molds have led to progress in the field of rapid prototyping their use is still limited to the prototyping phase. One reason for this is that they still tend to wear so that only a small number of products may be produced with one mold. Another reason is their drawback that products made within these molds cannot fulfill the requirements of surface properties expected from customers. Due to their surface roughness labor-intensive surface finishing would have to be made if these products should be sold in a large scale.

Hence, there is still need for a mold that can be produced cheaply, changed in design quickly and that can also be used for high pressure molding in a series production.

It would therefore be desirable and advantageous to provide an improved mold which obviates prior art shortcomings and which has a hard surface, a high melting point and is resistant to wear and which can be used in a series production while being easy and cheap to manufacture.

### SUMMARY OF THE INVENTION

According to one aspect of the present invention, a mold for producing an article to be formed therein includes a body made of a mold matrix material containing at least one type of carbon fibers, wherein the mold matrix material comprises a cured phenolic resin.

By using a mold matrix material made from phenolic resin and at least one type of carbon fibers a mold can be made that has a hard surface and is resistant to wear. It can be used with high pressure molding techniques and is therefore capable of replacing expensive steel molds. Due to the possibility of high pressure molding exceptionally shiny surfaces of the product can be achieved. The carbon fibers can be of any kind including refractory fibers, fibrils, short fibers, nano fibers, etc. The fibers can be arranged in mats, they can be distributed randomly or be arranged in layers or even changing their concentration gradually. The resin may be selected from any type of phenolic resins and may even be a mixture of different types of phenolic resins. Preferably, a water based liquid phenolic resin is used and mixed with a catalyst to cure the resin and form a rigid mold.

According to another feature of the present invention, the mold matrix material may have a flexural strength in the range of 250 to 500 Mpa and a flexural modulus in the range of 10 to 30 Gpa. The outstanding flexural properties respectively the high rigidity are allowing high pressure molding at high precision and low tolerances of the product.

According to another feature of the present invention, the mold matrix material may have a compressive strength in the range of 200 to 300 Mpa and a compressive modulus in the range of 5 to 15 GPa. This allows high pressure molding at similar molding conditions as used in serial production. Also the use of this mold is not limited to pre-production materials. Therefore prototypes comprising the same material and/or showing the same properties, particularly mechanical properties, like the material chosen for serial production can be used. Testing of these prototypes can deliver more reliable testing results and the testing phase can be shorter and cheaper.

According to another feature of the present invention, the mold matrix material may have a hardness in the range of 50 to 125 Vickers, whereby the mold matrix has a hard surface allowing minimal wear and/or a high number of pieces produced during the lifetime of the mold. The mold can be used also for molding reinforced materials like glass fiber reinforced thermoplastics.

According to another feature of the present invention, the mold matrix material may have a tensile modulus in the range of 15 to 40 GPa. The high rigidity of the mold enables high pressure molding at high precision and low tolerances of the product. High precision prototypes can be produced. As a result, more reliable measurements and testing on the prototypes are possible.

According to another feature of the present invention, the mold matrix material may have a tensile strength in the range of 150 to 350 Mpa. The high tensile strength of the mold is allowing high pressure molding. The use of a mold with such properties is not limited to prototyping but can also be used for serial production. Also a high dwell pressure can be applied allowing the production of parts with low shrinkage and a high precision and low tolerances in dimensions.

In particular, a mold matrix material can be made that has a continuous operating temperature above 350° C. and a transient operating temperature of up to 600° C. This allows molding with materials having a higher melting point than those used in the prior art.

The mold matrix material obtained can have a thermal conductivity in the range of 10 to 100 W/mK, preferably between 25 and 50 W/mK. This improved thermal conductivity allows replacing steel molds.

The mold made from the mold matrix material according to the invention can have an electric conductivity in the range of 10⁻⁴ Ωm to 10⁻² Ωm. Applying this electric conductivity to the mold matrix material makes it possible to heat the mold by resistive heating.

In a further aspect of the present invention the mold matrix material may further comprise at least one type of a filler material. By choosing proper filler materials it is possible to adjust or enhance the properties of the mold matrix material. These properties include hardness, rigidity, electrical and thermal conductivity, heat capacity, etc.

In this context the filler material may increase the electrical conductivity of the mold matrix material. Therefore, the filler material, or at least part thereof, may preferably comprise a metal, a precious metal, e.g. aluminium, copper, titanium and/or steel fibers.

The filler material may alternatively or additionally increase the thermal conductivity of the mold matrix material. Therefore, the filler material, or at least part thereof, may preferably comprise a metal, a ceramic, other materials, e.g. aluminium nitride, boron nitride, silicon nitride, steel fibers and/or graphite flakes.

According to another feature of the present invention, the mold includes a cooling system for cooling the mold, e.g. channels for a cooling liquid such as water or oil. It becomes therefore feasible to cool the mold and hence the product being formed therein. This allows shorter solidifying times of the product which results in a higher number of products being made in the same time. Hence, efficiency is improved and profit can be raised.

Preferably, the carbon fibers in the mold matrix material of the mold according to the present invention may include carbon nano fibers. It has been found out that the presence of carbon nano fibers in the mold matrix material dramatically improves the mechanical properties of the material. A mold matrix material made from phenolic resin comprising carbon nano fibers is significantly less prone to break or tear. However, it still retains its hard surface and high rigidity.

According to another feature of the present invention, the mold matrix material may contain at least two types of carbon fibers, one type of which including carbon nano fibers. Using both carbon fibers and carbon nano fibers results in less cost but still in a mold having the outstanding properties resulting from the carbon nano fibers.

According to another feature of the present invention, the at least two types of carbon fibers may be mixed homogeneously within the mold matrix material. This allows production of the mold in a single step and results in material properties that are uniform over the whole matrix material.

According to another feature of the present invention, the at least two types of carbon fibers may be arranged in layers within the mold matrix material. It is therefore possible to build up a cheap support part made from phenolic resin and usual carbon fibers.

In this context the carbon nano fibers may be arranged in a surface layer which is adapted to come—in use—into contact with the article to be formed within the mold. In this surface layer carbon nano fibers can be used to achieve the superior properties. Hence, overall cost of the mold is reduced while high surface quality of the product and high resistance against breaking or tearing of the mold are still attained.

In a specific embodiment the content of carbon nano fibers in the respective layer may be in a range between 10 to 70 wt % of the whole mold matrix material in the respective layer, preferably between 30 and 60 wt %, in particular 50 wt %.

According to another aspect of the present invention, a method of producing a mold includes the steps of mixing a liquid phenolic resin with at least one type of carbon fibers and a catalyst, allowing the mixture to cure to form a mold matrix material, applying the mold matrix material around a pattern, applying a temperature and a pressure to the matrix material for a predetermined time causing it to harden, and removing the pattern from the mold.

With this method a mold can be made having the superior qualities as outlined above can be made.

The method may preferably applied such that the temperature to harden the mold matrix material is less than 100° C., preferably in a range between 70° to 80° C. Therefore, a more accurate mold can be produced. It features a lower shrinkage due to the rather low curing temperature.

Preferably, the pressure to harden the mold matrix material can be less than 1000 psi, preferably in a range between 500 to 800 psi. This also results in a very accurate and precise mold.

According to a further feature of the present invention the method may further comprise the step of mixing to the liquid phenolic resin a filler material, which, or at least part thereof, is made preferably of a metal, a precious metal, a ceramic, other materials, e.g. aluminium, copper, titanium, aluminium nitride, boron nitride, silicon nitride, steel fibers and/or graphite flakes. By choosing proper filler materials it is possible to adjust or enhance the properties of the mold matrix material. These properties include hardness, rigidity, electrical and thermal conductivity, heat capacity, etc.

According to another feature of the present invention, the content of catalyst may be less than 5 wt % of the total weight of phenolic resin and catalyst. This rather small amount of catalyst will result in an even more accurate and precise mold with exact proportions.

Preferably, the method can be performed with the carbon fibers including carbon nano fibers. As already stated above, it has been found out that the presence of carbon nano fibers in the mold matrix material dramatically improves the mechanical properties of the material. A mold matrix material made according to the inventive method from phenolic resin comprising carbon nano fibers is significantly less prone to break or tear. However, it still retains its hard surface and high rigidity.

Advantageously, the mold matrix material can include at least two types of carbon fibers, one type of which including carbon nano fibers. Using both carbon fibers and carbon nano fibers results in less cost but still in a mold having the outstanding properties resulting from the carbon nano fibers.

According to another feature of the present invention, the step of mixing can be performed to obtain a homogenous mixture of the at least two types of carbon fibers. This allows production of the mold in a single step and results in material properties that are uniform over the whole matrix material.

According to another feature of the present invention, the step of mixing can be performed separately for the at least two types of carbon fibers, thereby obtaining at least two mixtures of mold matrix material. The method step of applying said mold matrix material around a pattern may then comprise the steps of applying a first mixture of mold matrix material, preferably the one containing said carbon nano fibers, around the pattern, thereby forming a first layer of mold matrix material; and applying a second mixture of mold matrix material around the obtained first layer enclosing the pattern, thereby forming a second layer of mold matrix material.

It is therefore possible to build up a cheap support part made from phenolic resin and usual carbon fibers. In the surface layer, i.e. the first layer around the pattern, carbon nano fibers can be used to achieve the superior properties. Hence, overall cost of the mold is reduced while high surface quality of the product and high resistance against breaking or tearing of the mold are still attained.

In this context the content of carbon nano fibers in the respective layer may advantageously be in a range between 10 to 70 wt % of the whole mold matrix material of the respective layer, preferably between 30 and 60 wt %, in particular 50 wt %.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic cross-sectional view of an assembled mold according to the present invention;

FIG. 2 is a cross-sectional view of a master pattern;

FIG. 3 is a cross-sectional view of a master pattern with an attached first layer of mold matrix material;

FIG. 4 is a schematic cross-sectional view of a further production step in producing a mold according to the present invention, wherein the bottom box of the mold is formed;

FIG. 5 is a schematic cross-sectional view of an even further production step in producing a mold according to the present invention, wherein the top box of the mold is formed;

FIG. 6 is a schematic view of the bottom box of a mold according to the present invention.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

Turning now to the drawing, and in particular to FIG. 1, there is shown a schematic cross-sectional view of an assembled mold according to the present invention, including a top box 1 and a bottom box 2. Top box 1 and bottom box 2 are made up from a mold matrix material containing at least one type of carbon fibers and a phenolic resin. Close to the surface on which a product will be formed in the cast there is provided an additional layer of matrix material which will be referred to from now on as “surface layer”.

In the specific embodiment described by way of example the main part of the top box 1 and the bottom box 2 constitute a support part that is made from a material containing phenolic resin and carbon fibers of any usual kind. The surface layer, however, is formed by a different mixture, in the particular preferred embodiment by a phenolic resin containing carbon nano fibers.

The assembled mold comprises a bottom plate 3 and side walls 4. These members can, in a way known from the prior art, be made from steel or any other material that can bear the loads applied during the manufacture process.

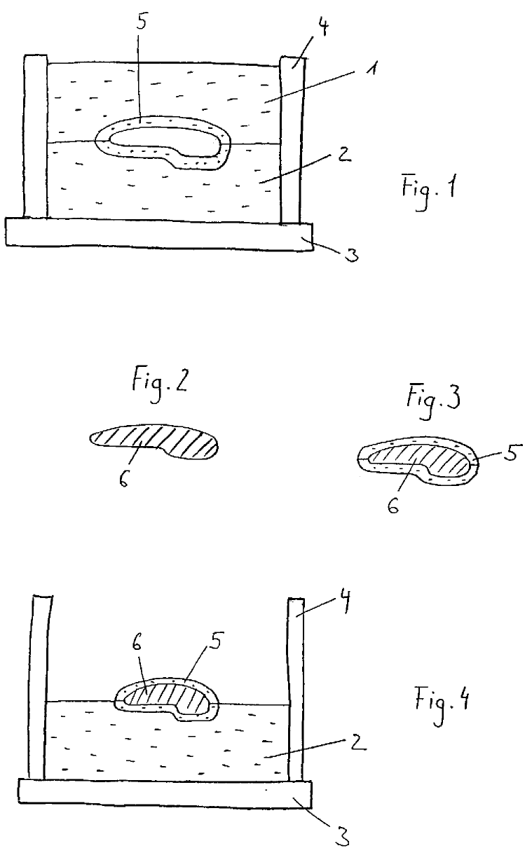

In the following a process of making a mold according to the invention will be described with reference to FIGS. 2 to 5.

In a first step a liquid water-based phenolic resin is mixed with a first type of carbon fibers, in the particular embodiment carbon nano fibers. The most preferred commercial range of carbon nano fiber content is 30 to 60 weight percent of such carbon nano fibers in the whole mass of resin and fibers. A preferred type of phenolic resin therefore is the one being known as Cellobond J2027L from Borden Chemical UK Ltd. As a next step, a catalyst is added to mixture. Therefore, a product named Phencat 382 (Cellobond) is most preferred. The content of catalyst being used is smaller or close to 5% and hence lies well below the usually recommended value of 5 to 10%. The composition obtained is a modeling-clay-like carbon nano fiber “green paste”, containing phenolic resin, catalyst and carbon nano fibers. Using the thixotropic form of the resin allows a wider variation of the carbon nano fiber content.

As a next step a master pattern will be coated with this modeling-clay-like carbon nano fiber paste. The coating will later form the surface layer of the mold and ensure good material properties of the mold including strength, heat dissipation, surface finish, resistance to wear and ease of use. Before the modeling clay can be applied, it will be necessary to apply a release agent to the master pattern. While in the prior art polyvinyl alcohol has been used as release agent, now a silicone containing release agent is preferred. The release agent is simply sprayed several microns on the model's surface. Next, the modeling clay will be applied like gravel to the model, therefore allowing air to escape. Inside the paste bubbles remaining from the mixing process can escape via the nano fibers when a pressure is applied during further production steps. The modeling clay will have a thickness of 10 to 30 mm on the master pattern, but could also be much thicker. It would even be possible to make the whole mold from this material and hence substitute any carbon fiber of usual kind completely. This would, however, result in an unreasonably expensive mold.

In a further step, a liquid water-based phenolic resin is mixed with a second type of carbon fibers, e.g. short fibers of a conventional kind of carbon fibers. The most preferred commercial range of carbon fiber content is 55 to 60 weight percent of such carbon fibers in the whole mass of resin and fibers. A preferred type of phenolic resin therefore is again the one being known as Cellobond J2027L from Borden Chemical UK Ltd.

As a next step, a catalyst is added to mixture. Therefore, also the product named Phencat 382 (Cellobond) is most preferred. The content of catalyst being used is smaller or close to 5% and hence lies well below the usually recommended value of 5 to 10%.

With this second mixture of phenolic resin containing carbon fibers the top box 1 and the bottom box 2 will now be formed. This can be done in ways already known in the prior art, with particular reference to the method disclosed in British Patent Application GB 2 360 244 A. As a difference, much lower molding pressure as shown in FIG. 5 and much lower molding temperatures can be used. It is therefore preferred to perform the step of applying a temperature and a pressure to the matrix material for a predetermined time with the following values:

preferred molding pressure: 500 to 800 psi (35 to 55 bar)

preferred molding temperature: 70 to 80° C.

curing time: less than one hour.

The pressure can most easily be applied to the top member 7 of the mold.

Shelf life of the premixed paste for the phenolic mold according to the invention is typically up to one hour, but could be even as long as three months. In comparison to this, the shelf life of polyurethane resin used in the prior art is about 7 to 12 minutes. Hence, ease of use is considerably improved.

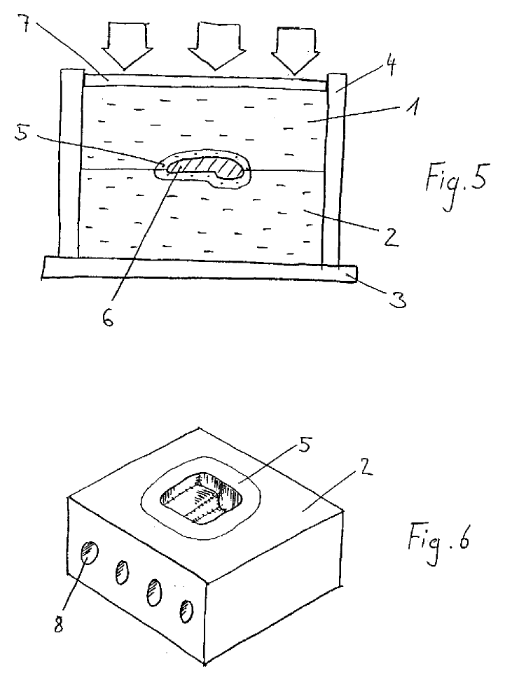

In this way, the top box 1 and the bottom box 2 are produced in a quick and relatively cheap way. FIG. 6 shows a schematic view of a bottom box 2 according to the present invention. Additionally top the features already described this bottom box 2 has channels 8 for a cooling liquid. By guiding water or oil through these channels the mold and hence the product therein can be cooled. The product will hence solidify in a much shorter time which results in a considerably improved efficiency of the molding process.

Moreover, although several embodiments of the invention have been described with reference to the accompanied drawings, the invention is not limited to these specific embodiments. In particular, not all features need be present in the described combination. Instead, any other combination of features falling within the scope of the appended claims may be applied.

In any case, this new type of mold matrix material has completely superior qualities to materials known from the prior art. It allows for the first time repeatable quality plastic parts to be injection molded from a resin tool. Sizes, weights, material specifications and surface finish of the product formed in such a mold are far superior to those previously attained and are identical to the qualities of conventionally molded parts, presently using steel and/or aluminium dies.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A mold for producing an article to be formed therein, comprising a body made of a mold matrix material containing at least one type of carbon fibers, wherein the mold matrix material comprises a cured phenolic resin.

2. The mold of claim 1, wherein the mold matrix material has a flexural strength in the range of 250 to 500 MPa, and a flexural modulus in the range of 10 to 30 GPa.

3. The mold of claim 1, wherein the mold matrix material has a compressive strength in the range of 200 to 300 MPa, and a compressive modulus in the range of 5 to 15 GPa.

4. The mold of claim 1, wherein the mold matrix material has a hardness in the range of 50 to 125 Vickers.

5. The mold of claim 1, wherein the mold matrix material has a tensile modulus in the range of 15 to 40 GPa.

6. The mold of claim 1, wherein the mold matrix material has a tensile strength in the range of 150 to 350 MPa.

7. The mold of claim 1, wherein the mold matrix material has a continuous operating temperature above 350° C. and a transient operating temperature of up to 600° C.

8. The mold of claim 1, wherein the mold matrix material has a thermal conductivity in the range of 10 to 100 W/mK.

9. The mold of claim 1, wherein the mold matrix material has a thermal conductivity in the range of between 25 and 50 W/mK.

10. The mold of claim 1, wherein the mold matrix material has an electric conductivity in the range of 10⁻⁴ Ωm to 10⁻² Ωm.

11. The mold of claim 1, wherein the mold matrix material includes at least one type of a filler material.

12. The mold of claim 11, wherein the filler material increases an electrical conductivity of the mold matrix material.

13. The mold of claim 12, wherein at least part of the filler material is made of a material selected from the group consisting of metal and precious metal.

14. The mold of claim 13, wherein the filler material is selected from the group consisting of aluminium, copper, titanium and/or steel fibers.

15. The mold of claim 8, wherein the filler material increases a thermal conductivity of the mold matrix material.

16. The mold of claim 15, wherein at least part of the filler material is made of a material selected from the group consisting of metal, ceramic, and another material.

17. The mold of claim 16, wherein the filler material is selected from the group consisting of aluminium nitride, boron nitride, silicon nitride, steel fibers and/or graphite flakes.

18. The mold of claim 1, further comprising cooling means for cooling the body.

19. The mold of claim 18, wherein the cooling means includes channels formed in the body for passage of a coolant.

20. The mold of claim 19, wherein the coolant is water or oil.

21. The mold of claim 1, wherein the carbon fibers include carbon nano fibers.

22. The mold of claim 1, wherein the mold matrix material contains at least two types of carbon fibers, one type of which including carbon nano fibers.

23. The mold of claim 22, wherein the at least two types of carbon fibers are mixed homogeneously within the mold matrix material.

24. The mold of claim 22, wherein the at least two types of carbon fibers are arranged in layers within the mold matrix material.

25. The mold of claim 24, wherein the carbon nano fibers are arranged in a surface layer which is adapted to come into contact with the article to be formed within the mold, when the mold is in use.

26. The mold of claim 24, wherein a content of carbon nano fibers in each of the layers is in a range between 10 to 70 wt % of the whole mold matrix material in the respective layer.

27. The mold of claim 24, wherein a content of carbon nano fibers in each of the layers is in a range between 30 and 60 wt % of the whole mold matrix material in the respective layer.

28. The mold of claim 24, wherein a content of carbon nano fibers in each of the layers is 50 wt % of the whole mold matrix material in the respective layer.

29. A Method of producing a mold, comprising the steps of: mixing a liquid phenolic resin with at least one type of carbon fibers and a catalyst;
allowing the mixture to cure to form a mold matrix material;
applying the mold matrix material around a pattern;
applying a temperature and a pressure to the matrix material for a predetermined time causing it to harden; and
removing the pattern from the mold.

30. The method of claim 29, wherein the temperature to harden the mold matrix material is less than 100° C.

31. The method of claim 29, wherein the temperature to harden the mold matrix material ranges between 70° to 80° C.

32. The method of claim 29, wherein the pressure to harden the mold matrix material is less than 1000 psi.

33. The method of claim 29, wherein the pressure to harden the mold matrix material ranges between 500 to 800 psi.

34. The method of claim 29, further comprising the step of mixing a filler material to the liquid phenolic resin.

35. The method of claim 34, wherein at least part of the filler material is made of a material selected from the group consisting of metal, precious metal, ceramic, and another material.

36. The method of claim 35, wherein the filler material is selected from the group consisting of aluminium, copper, titanium, aluminium nitride, boron nitride, silicon nitride, steel fibers and/or graphite flakes.

37. The method of 29, wherein a content of catalyst is less than 5 wt % of the total weight of phenolic resin and catalyst.

38. The method of claim 29, wherein the carbon fibers include carbon nano fibers.

39. The method of claim 29, wherein the mold matrix material includes at least two types of carbon fibers, one type of which including carbon nano fibers.

40. The method of claim 39, wherein the mixing step is performed until obtaining a homogenous mixture of the at least two types of carbon fibers.

41. The method of claim 39, wherein the mixing step includes the step of separately admixing the at least two types of carbon fibers, thereby obtaining at least two mixtures of mold matrix material, said applying step including the steps of applying one of the two mixtures of mold matrix material around the pattern, thereby forming a first layer of mold matrix material, and applying the other one of the mixtures of mold matrix material around the obtained first layer enclosing the pattern, thereby forming a second layer of mold matrix material.

42. The method of claim 41, wherein the one of the mixtures is the mixture containing the carbon nano fibers.

43. The method of claim 41, wherein a content of carbon nano fibers in a respective one of layers is in a range between 10 to 70 wt % of the whole mold matrix material in the respective layer.

44. The method of claim 41, wherein a content of carbon nano fibers in a respective one of layers is in a range between 30 and 60 wt % of the whole mold matrix material in the respective layer.

45. The method of claim 41, wherein a content of carbon nano fibers in a respective one of layers is 50 wt % of the whole mold matrix material in the respective layer.
